(19) United States
(12) Patent Application Publication
(10) Pub. No.: US 2026/0167151 A1
(43) Pub. Date: Jun. 18, 2026

(54) SYSTEM FOR PERFORMING PRE-AUTHENTICATION AND METHOD THEREOF

(71) Applicants: Hyundai Motor Company, Seoul (KR); Kia Corporation, Seoul (KR)

(72) Inventors: Hang Hang WANG, Yantai (CN); Kyong Ho SHON, Hwaseong-Si (KR); Xi Sha LI, Yantai (CN); In Sik CHUN, Hwaseong-Si (KR); Jin Shun LI, Yantai (CN)

(73) Assignees: Hyundai Motor Company, Seoul (KR); Kia Corporation, Seoul (KR)

(21) Appl. No.: 19/002,327

(22) Filed: Feb. 21, 2025

(30) Foreign Application Priority Data
Dec. 17, 2024 (CN) 202411857766.1

(51) Int. Cl. B60R 25/24; B60R 25/01; G07C 9/00; H04B 17/318

(52) U.S. Cl. CPC B60R 25/245; B60R 25/01; G07C 9/00309; H04B 17/318; B60R 2325/101; B60R 2325/205; G07C 2009/00793; G07C 2209/08; G07C 2209/63

(57) ABSTRACT

In a system for performing pre-authentication and a method thereof, the pre-authentication performing system includes an integrated control unit configured to perform pre-authentication with a mobile device in which a digital key is provided when the mobile device enters a predetermined authentication area and an authentication control unit configured to perform pre-authentication with the integrated control unit when the pre-authentication with the mobile device is successful and store a result of performing the pre-authentication.

### CROSS-REFERENCE TO RELATED APPLICATION

The present application claims priority to Chinese Patent Application No. 202411857766.1, filed on Dec. 17, 2024, the entire contents of which is incorporated herein for all purposes by this reference.

### BACKGROUND OF THE PRESENT DISCLOSURE

### Field of the Present Disclosure

The present disclosure relates to a system for performing pre-authentication and a method thereof.

### Discussion of Related Art

With rapid development of digital key technology applied to vehicles, the number of vehicle models using digital keys is increasing. The digital key technology allows users to access their vehicles through Near Field Communication (NFC) and Bluetooth low energy (BLE) between mobile devices or the like and the vehicles.

In the instant case, wireless authentication is performed between the vehicles and the mobile devices while using the digital keys.

However, the connection speed to the vehicle is slow depending on the performance difference of the mobile device. In the case of some lower performance mobile devices, a time for wireless authentication with the vehicle may be delayed. Therefore, methods capable of reducing the time for wireless authentication with the vehicle are required.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a system for performing pre-authentication and a method thereof.

Problems to be solved in the exemplary embodiments of the present disclosure are not limited to the above-described problems, and objects and effects which may be determined from the technical solutions and embodiments described below are also included.

According to various aspects of the present disclosure, there is provided a system for performing pre-authentication including an integrated control unit configured to perform pre-authentication with a mobile device in which a digital key is provided when the mobile device enters a predetermined authentication area and an authentication control unit configured to perform pre-authentication with the integrated control unit when the pre-authentication with the mobile device is successful and store a result of performing the pre-authentication.

The integrated control unit may check whether the mobile device is approaching a vehicle when the mobile device enters the authentication and perform the pre-authentication when the mobile device approaches the vehicle.

The integrated control unit may be configured to detect a received signal strength indicator (RSSI) of a wireless signal received from the mobile device and check whether the mobile device is approaching the vehicle based on the detected RSSI.

The integrated control unit may be configured to check whether the number of times the pre-authentication is performed exceeds n times (n is a positive integer) when the performing of the pre-authentication is determined, and perform the pre-authentication when the number of times the pre-authentication is performed does not exceed n times.

The integrated control unit may be configured to check whether the number of times the pre-authentication fails is m times (m is a positive integer) when the number of times the pre-authentication is performed does not exceed n times and perform the pre-authentication when the number of times the pre-authentication fails is not m times.

The integrated control unit may be configured to start a timer to count a time when the pre-authentication is successful as the result of performing the pre-authentication and perform the pre-authentication again based on the counted time.

The integrated control unit may be configured to check whether there is another mobile device that has been successfully authenticated when the performing of the pre-authentication is determined, and perform the pre-authentication with a mobile device having a shortest distance from the vehicle among all mobile devices when there is another mobile device that has been successfully authenticated.

The integrated control unit may be configured to determine distance values of a mobile device that has been successfully authenticated first and mobile devices that have been successfully authenticated later when there is another mobile device that has been successfully authenticated and determine a difference value between the distance values and perform connection to the mobile device that has been successfully authenticated first when the determined difference value is greater than a predetermined threshold value.

The integrated control unit may perform connection to a mobile device having a minimum distance value from the vehicle among all mobile devices when the determined difference value is equal to or lower than the predetermined threshold value.

The authentication control unit may transmit the result of performing the pre-authentication to the integrated control unit when a button operation is requested from the integrated control unit during a period in which the pre-authentication is successful.

According to various aspects of the present disclosure, there is provided a method of performing pre-authentication, including performing, by an integrated control unit, pre-authentication with a mobile device in which a digital key is provided when the mobile device enters a predetermined authentication area and performing pre-authentication with the integrated control unit when the pre-authentication with the mobile device is successful and storing a result of performing the pre-authentication.

In the performing of the pre-authentication, it may be checked whether the mobile device is approaching a vehicle when the mobile device enters the authentication area, and the pre-authentication may be performed when the mobile device is approaching the vehicle.

In the performing of the pre-authentication, a received signal strength indicator (RSSI) of a wireless signal received from the mobile device may be detected, and it may be checked whether the mobile device is approaching the vehicle based on the detected RSSI.

In the performing of the pre-authentication, it may be checked whether the number of times the pre-authentication is performed exceeds n times (n is a positive integer) when the performing of the pre-authentication is determined, and the pre-authentication may be performed when the number of times the pre-authentication is performed does not exceed n times.

In the performing of the pre-authentication, it may be checked whether the number of times the pre-authentication fails is m times (m is a positive integer) when the number of times the pre-authentication is performed does not exceed n times, and the pre-authentication may be performed when the number of times the pre-authentication fails is not m times.

In the performing of the pre-authentication, a timer may be started to count a time when the pre-authentication is successful as the result of performing the pre-authentication, and the pre-authentication may be performed again based on the counted time.

In the performing of the pre-authentication, it may be checked whether there is another mobile device that has been successfully authenticated when the performing of the pre-authentication is determined, and the pre-authentication with a mobile device having a shortest distance from the vehicle among all mobile devices may be performed when there is another mobile device that has been successfully authenticated.

In the performing of the pre-authentication, distance values of a mobile device that has been successfully authenticated first and mobile devices that have been successfully authenticated later may be determined when there is another mobile device that has been successfully authenticated, and a difference value between the distance values may be determined and connection to the mobile device that has been successfully authenticated first may be performed when the determined difference value is greater than a predetermined threshold value.

In the performing of the pre-authentication, connection to a mobile device having a minimum distance value from the vehicle among all mobile devices may be performed when the determined difference value is equal to or lower than the predetermined threshold value.

In the storing of the result, the result of performing the pre-authentication may be transmitted to the integrated control unit when a button operation is requested from the integrated control unit during a period in which the pre-authentication is successful.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view exemplarily illustrating a system for performing pre-authentication according to various exemplary embodiments of the present disclosure;

FIG. 2 is a view exemplarily illustrating a method for performing pre-authentication according to various exemplary embodiments of the present disclosure;

FIG. 3 is a view for describing an area where pre-authentication is performed;

FIG. 4 is a view exemplarily illustrating a process of performing pre-authentication according to various exemplary embodiments of the present disclosure;

FIG. 5 is a view exemplarily illustrating a process of performing pre-authentication according to various exemplary embodiments of the present disclosure;

FIG. 6 is a view exemplarily illustrating a case where multiple mobile devices exist in an authentication area; and

FIG. 7 is a view exemplarily illustrating a process of processing authentication logic according to various exemplary embodiments of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, exemplary embodiments of the present disclosure will be described in detail with reference to the accompanying drawings.

However, the technical idea of the present disclosure is not limited to various exemplary embodiments to be described but may be implemented in various different forms, and within the scope of the technical idea of the present disclosure, one or more among components in the exemplary embodiments of the present disclosure may be used by being selectively combined and substituted.

Furthermore, unless specifically defined and described, terms used in the exemplary embodiments of the present disclosure (including technical and scientific terms) may be interpreted as meanings which are generally understood by those skilled in the art to which an exemplary embodiment of the present disclosure pertains, and commonly used terms such as terms defined in the dictionary may be interpreted based on the contextual meaning of the related art.

The terms used in the exemplary embodiments of the present disclosure are for describing the exemplary embodiments only and are not intended to limit the present disclosure.

In the present specification, the singular forms may include the plural forms unless the context clearly dictates otherwise, and when described as “at least one (or one or more) among A, B, and (or) C,” it may include at least one of all possible combinations of A, B, and C.

Furthermore, in describing a component of embodiments of the present disclosure, terms such as first, second, A, B, (a), (b), etc., may be used.

These terms are only for distinguishing the component from other components, and the essence, sequence, or order of the component is not limited by the terms.

Furthermore, when a component is described as being “linked,” “coupled,” or “connected” to another component, the component is not only directly linked, coupled, or connected to another component, but can also be “linked,” “coupled,” or “connected” to another component with yet another component disposed between the component and the other component.

Furthermore, when a component is described as being formed or disposed “on (above) or under (below)” of another component, the term “on (above) or under (below)” includes not only when two components are in direct contact with each other, but also when one or more of other components are formed or disposed between the two components. Furthermore, when a component is described as being “on (above) or below (under),” the description may include the meanings of an upward direction and a downward direction based on one component.

In embodiments, a new way to automatically perform periodic pre-authentication when a user's mobile device enters a pre-authentication area adjacent to a vehicle is to be suggested.

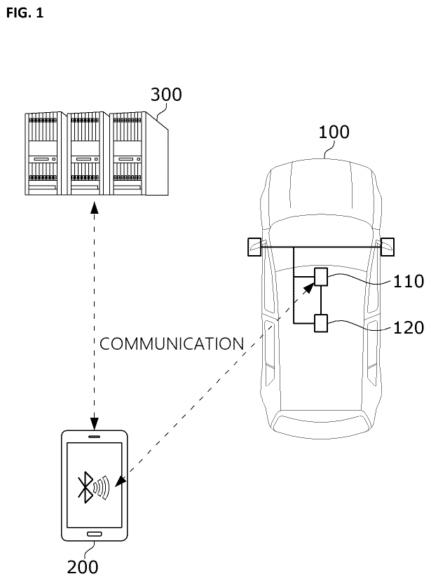

FIG. 1 is a view exemplarily illustrating a system for performing pre-authentication according to various exemplary embodiments of the present disclosure.

Referring to FIG. 1, the system for performing pre-authentication according to the exemplary embodiment of the present disclosure may include a vehicle 100, a mobile device 200, and a server 300, and the vehicle 100 may include an integrated control unit 110 and an authentication control unit 120.

The integrated control unit 110 may be wirelessly interworked with the mobile device 200 and manage the wireless connection to the mobile device 200. The integrated control unit 110 may obtain location information related to the mobile device 200 based on a wireless signal received from the wirelessly connected mobile device 200.

In the instant case, the integrated control unit 110 and the mobile device 200 may be wirelessly interworked through low-power Bluetooth communication, but are not necessarily limited thereto, and wireless interworking may be possible through ultra-wideband (UWB) communication, Near Field Communication (NFC), or the like.

The integrated control unit 110 is interworked with the authentication control unit 120 and may obtain vehicle state information, such as a power supply state, a door lock state, and the like, from the authentication control unit 120. The authentication control 120 unit can collect the vehicle state information when the button, door, and the like are operated. The integrated control unit 110 may perform first pre-authentication with the mobile device 200 using a digital key and transmit an authentication request message including a result of performing the first pre-authentication to the authentication control unit 120, so that second pre-authentication with the authentication control unit 120 may be periodically performed.

The authentication control unit 120 may be interworked with the integrated control unit 110, and may transmit the vehicle state information to the integrated control unit 110. The authentication control unit 120 may receive the authentication request message from the integrated control unit 110 and perform second pre-authentication with the integrated control unit 110. Here, the authentication request message may include the result of performing the first pre-authentication and location information related to the mobile device 200, but is not limited thereto.

The mobile device 200 may be interworked with the vehicle 100, perform pre-authentication with the vehicle using a digital key, and control various functions included in the vehicle 100 when pre-authentication is successful. The digital key may be implemented as an application on the mobile device without a physical appearance.

The mobile device 200 may communicate with the integrated control unit 110 in the vehicle through wireless communication such as low-power Bluetooth communication, but is not necessarily limited thereto.

The server 300 may be interworked with the mobile device 200 and provide the digital key to the mobile device 200. The server 300 may use and store a unique number of the digital key.

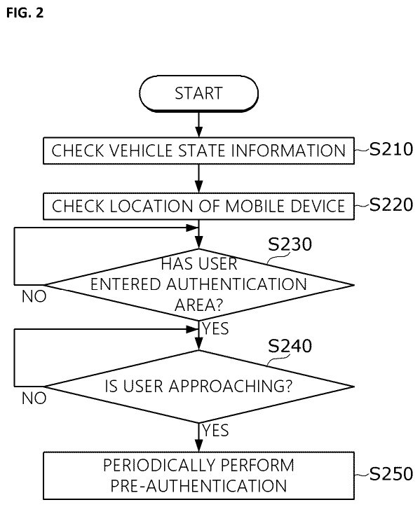

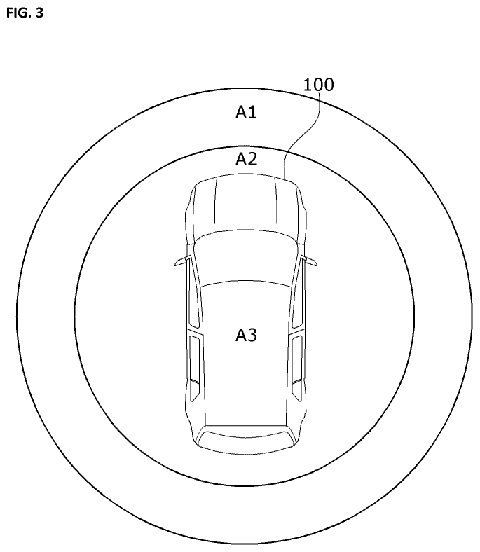

FIG. 2 is a view exemplarily illustrating a method for performing pre-authentication according to various exemplary embodiments of the present disclosure, and FIG. 3 is a view for describing an area where pre-authentication is performed.

Referring to FIG. 2, a system for performing pre-authentication according to various exemplary embodiments of the present disclosure (referred to as a pre-authentication system) may obtain vehicle state information from the authentication control unit 120 and check a state of a vehicle based on the vehicle state information (S210).

Next, the pre-authentication system may obtain location information related to a mobile device (S220).

Next, the pre-authentication system may check whether a user using the mobile device has entered a predetermined authentication area based on the obtained location information related to the mobile device (S230).

As illustrated in FIG. 3, the authentication area may include a first area A1 for checking a location of the mobile device, a second area A2 for performing pre-authentication, and a third area A3 for performing start-up authentication. Here, the pre-authentication system checks whether the mobile device has entered the second area A2.

The first area A1 and the second area A2 are predetermined areas centered around the vehicle, but are not limited thereto. In the instant case, the first area A1 and the second area A2 are areas outside the vehicle and may be changed according to a request of a user. The third area A3 may be an area inside the vehicle.

Next, the pre-authentication system may check whether the user is approaching the vehicle when the user enters the authentication area (S240). For example, the pre-authentication system may continuously check a received signal strength indicator (RSSI) of a wireless signal received from the mobile device and check whether the user is approaching the vehicle based on the checked RSSI.

Next, the pre-authentication system may periodically perform the pre-authentication with the mobile device when the user is approaching the vehicle (S250). In the present way, the pre-authentication system may be configured for controlling the vehicle by periodically performing the pre-authentication with the mobile device.

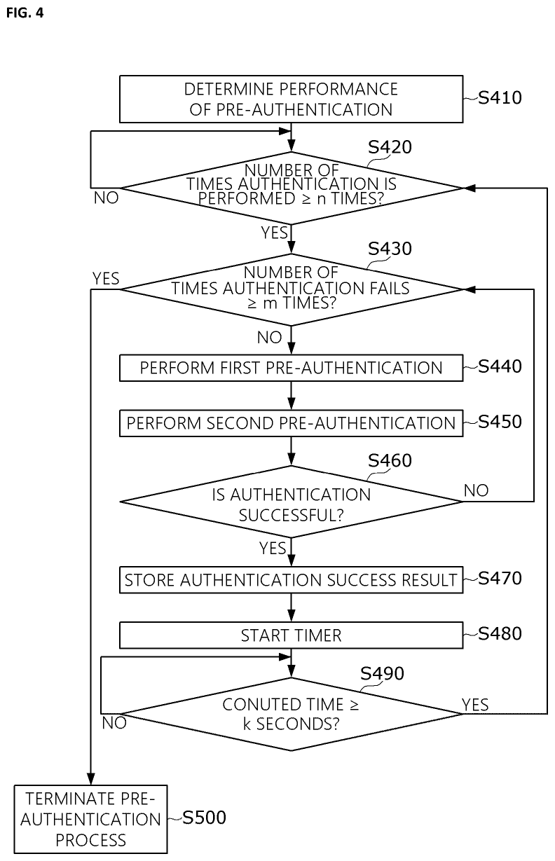

FIG. 4 is a view showing a process of performing pre-authentication according to various exemplary embodiments of the present disclosure.

Referring to FIG. 4, a system for performing pre-authentication according to various exemplary embodiments of the present disclosure (referred to as a pre-authentication system) may check whether the number of times pre-authentication is performed is greater than or equal to n times (n is a positive integer) (S420) when periodic performance of pre-authentication is determined (S410).

That is, in the exemplary embodiment of the present disclosure, pre-authentication is periodically performed, but up to n times.

Next, the pre-authentication system may check whether the number of times authentication fails is greater than or equal to m times (m is a positive integer) when the number of times the authentication is performed is less than n times (S430). On the other hand, the pre-authentication system may terminate the pre-authentication process without performing the authentication when the number of times the authentication is performed is greater than or equal to n times and the number of times authentication fails is greater than or equal to m times.

In the instant case, the number of times the authentication fails may indicate the number of times the authentication consecutively fails. That is, when the authentication is successful after the authentication failure, the number of times the authentication fails may be reset to 0 times.

Next, the pre-authentication system may perform the pre-authentication when the number of times the authentication fails is less than m times (S440, S450). For example, the pre-authentication system may perform first pre-authentication between a mobile device and an integrated control unit (S440) and second pre-authentication which is performed between the integrated control unit and an authentication control unit (S450).

Next, the pre-authentication system may check whether the pre-authentication is successful (S460). The pre-authentication system may check whether both the first and second pre-authentication are successful. Therefore, the pre-authentication system may be configured to determine that pre-authentication is not successful when either the first or second pre-authentication fails.

Next, the pre-authentication system may store an authentication success result (S470) and start a timer to count the time (S480). The timer may count the time each time the authentication success result is stored.

Next, the pre-authentication system may check whether the counted time is greater than or equal to k seconds (S490). The pre-authentication system may be configured to determine that the pre-authentication validity period has expired when the counted time is greater than or equal to k seconds and repeat the process of performing pre-authentication again.

Furthermore, there may be cases where there are multiple mobile devices with smart keys provided, and users using the multiple mobile devices may simultaneously access the vehicle. Hereinafter, a process of performing pre-authentication using multiple smart keys will be described.

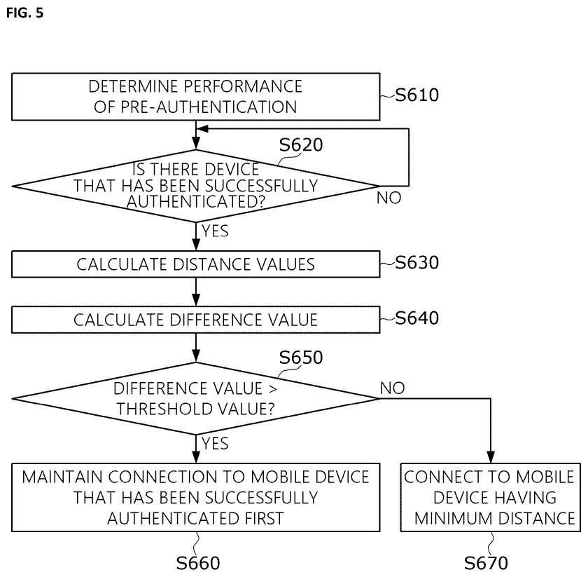

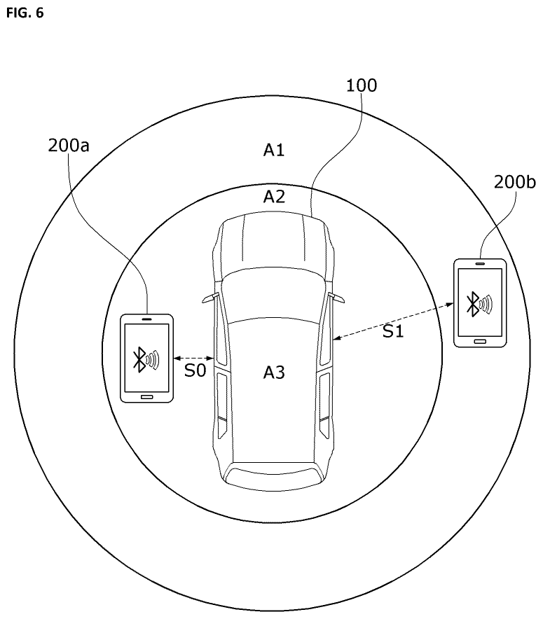

FIG. 5 is a view exemplarily illustrating a process of performing pre-authentication according to various exemplary embodiments of the present disclosure, and FIG. 6 is a view exemplarily illustrating a case where multiple mobile devices exist in an authentication area.

Referring to FIG. 5, a system for performing pre-authentication according to various exemplary embodiments of the present disclosure (referred to as a pre-authentication system) may check whether there is another mobile device that has been successfully authenticated (S620) when periodic performance of pre-authentication is determined (S610).

Next, the pre-authentication system may be configured to determine distance values between the vehicle and all mobile devices when there is another mobile device that has been successfully authenticated (S630). For example, as illustrated in FIG. 6, when two mobile devices 200a and 200b are successfully authenticated, distance values S0 and S1 of each mobile device may be determined.

Next, the pre-authentication system may be configured to determine a difference value of the determined distance values (S640). In the instant case, the difference value may be set as a difference between a distance value of the mobile device that has been successfully authenticated first and a minimum distance value of a mobile device that has been successfully authenticated later. That is, when there are multiple mobile devices that have been successfully authenticated later, the difference value may be determined using only a minimum distance value.

Next, the pre-authentication system may compare the determined difference value with a predetermined threshold value (S650). That is, the pre-authentication system may check whether the determined difference value is greater than the threshold value.

Next, when the difference value is greater than the threshold value, the pre-authentication system is configured to determine that the distance between the mobile device that has been successfully authenticated first and the mobile device that has been successfully authenticated later is large, and thus may maintain connection to the mobile device that has been successfully authenticated first (S660).

On the other hand, when the difference value is not greater than the threshold value, the pre-authentication system is configured to determine that the distance between the mobile device that has been successfully authenticated first and the mobile device that has been successfully authenticated later is not large, and may perform connection to the mobile device having the minimum distance value among all mobile devices (S670).

Here, a case where connection to a mobile device having the minimum distance value is performed when multiple mobile devices are approaching is described as an exemplary embodiment of the present disclosure, but the exemplary embodiment of the present disclosure is not necessarily limited thereto. For example, the exemplary embodiment of the present disclosure may be set to perform connection to the mobile device that has been successfully authenticated first.

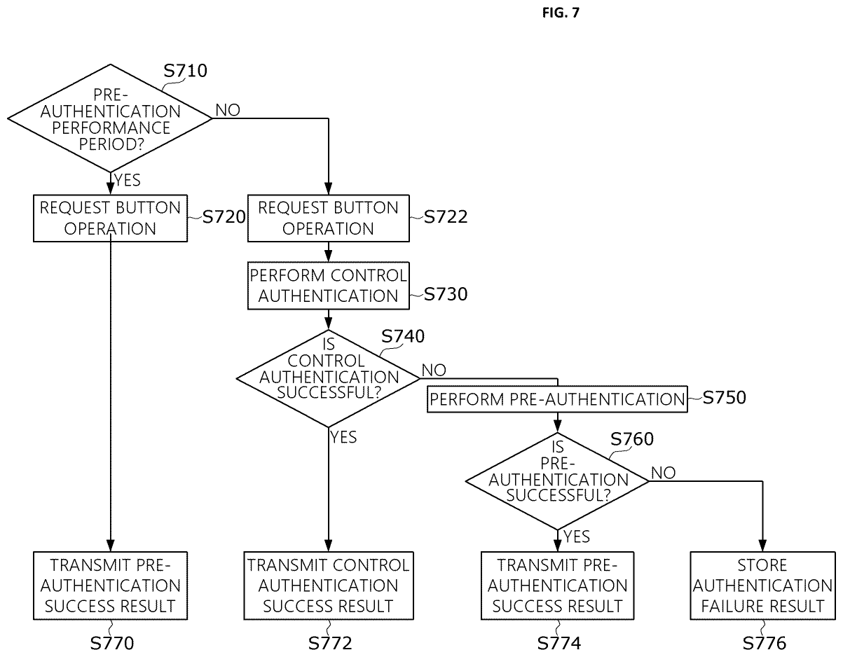

FIG. 7 is a view exemplarily illustrating a process of processing authentication logic according to various exemplary embodiments of the present disclosure.

Referring to FIG. 7, an integrated control unit according to the exemplary embodiment of the present disclosure may transmit a request message for a button operation request to an authentication control unit (S720) when a button operation is input during the pre-authentication performance period (S710). For example, a button may be a hand-held toggle button for locking a vehicle door.

Next, when the authentication control unit receives the request message, the authentication control unit may be configured to generate a response message including a pre-authentication success result and transmit the response message to the integrated control unit (S770).

On the other hand, when the button operation is input after the pre-authentication performance period has elapsed, the integrated control unit may transmit a request message requesting control authentication for the button operation request to the authentication control unit (S722).

Next, when the authentication control unit receives the request message, the authentication control unit may perform control authentication with the integrated control unit (S730), and when the control authentication is successful as a result of the performance (S740), the authentication control unit may transmit a response message including a control authentication success result to the integrated control unit (S772).

On the other hand, when the control authentication fails (S740), the authentication control unit may perform pre-authentication with the integrated control unit (S750), and when the pre-authentication is successful as a result of the performance (S760), the authentication control unit may transmit a response message including a pre-authentication success result to the integrated control unit (S774).

On the other hand, the authentication control unit may store an authentication failure result (S776) when the pre-authentication is not successful (S760). In the instant case, when the pre-authentication is not successful, the authentication control unit may be configured to determine that all authentications have failed and may not transmit a separate response message to the control unit.

Since the pre-authentication is performed in advance in the instant way when a mobile device approaches a vehicle, the vehicle may be controlled without performing separate authentication to control the vehicle.

The term “unit” used in an exemplary embodiment of the present disclosure refers to software component or hardware components such as a field-programmable gate array (FPGA) or an application specific integrated circuit (ASIC), and “unit” is configured to perform certain functions. However, the “˜unit” is not limited to software or hardware. The “˜unit” may be configured to reside in an addressable storage medium, or may be configured to reproduce one or more processors. Therefore, for example, “unit” includes components such as software components, object-oriented software components, class components, and task components, and includes processes, functions, attributes, procedures, sub-routines, segments of program code, drivers, firmware, micro codes, circuits, data, a database, data structures, tables, arrays, and variables. Functions provided in the components and the “˜unit” may be coupled with lesser numbers of components and “˜units,” or may be further divided into additional components and “˜units.” Furthermore, the components and “˜units” may be implemented to reproduce one or more CPUs in a device or a security multimedia card.

According to various exemplary embodiments of the present disclosure, by automatically performing pre-authentication periodically when a user's mobile device enters a pre-authentication area adjacent to a vehicle, it is possible to reduce a user waiting time due to differences in mobile device performance.

According to various exemplary embodiments of the present disclosure, it is possible to easily control a vehicle by reducing a user waiting time.

Furthermore, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), Silicon Disk Drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like. Furthermore, the computer-readable recording medium may be distributed over computer systems connected through a network, and computer-readable program code may be stored and executed in a distributive manner.

In various exemplary embodiments of the present disclosure, each operation described above may be performed by a control device, and the control device may be configured by multiple control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well known to a person including ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, multiple operations may be merged, or any operation may be divided, and a specific operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A system for performing pre-authentication, the system comprising:
an integrated control unit configured to perform pre-authentication with a mobile device in which a digital key is provided, in response that the mobile device enters a predetermined authentication area; and
an authentication control unit configured to perform pre-authentication with the integrated control unit in response that the pre-authentication with the mobile device is successful and store a result of performing the pre-authentication.

2. The system of claim 1, wherein the integrated control unit is further configured to check whether the mobile device is approaching a vehicle in response that the mobile device enters the authentication area, and is configured to perform the pre-authentication in response that the mobile device approaches the vehicle.

3. The system of claim 2, wherein the integrated control unit is further configured to:
detect a received signal strength indicator (RSSI) of a wireless signal received from the mobile device; and
check whether the mobile device is approaching the vehicle based on the detected RSSI.

4. The system of claim 1, wherein the integrated control unit is further configured to:
check whether a number of times the pre-authentication is performed is greater than or equal to n times in response that the performing of the pre-authentication is determined, wherein the n is a positive integer; and
perform the pre-authentication in response that the number of times the pre-authentication is performed is less than the n times.

5. The system of claim 4, wherein the integrated control unit is further configured to:
check whether a number of times the pre-authentication fails is greater than or equal to m times in response that the number of times the pre-authentication is performed does is less than the n times, wherein the m is a positive integer; and
perform the pre-authentication in response that the number of times the pre-authentication fails is not the m times.

6. The system of claim 5, wherein the integrated control unit is further configured to:
start a timer to count a time when the pre-authentication is successful as the result of performing the pre-authentication; and
perform the pre-authentication again based on the counted time.

7. The system of claim 1, wherein the integrated control unit is further configured to:
check whether there is another mobile device that has been successfully authenticated in response that the performing of the pre-authentication is determined; and
perform the pre-authentication with a mobile device having a shortest distance from the vehicle among all mobile devices in response that there is the another mobile device that has been successfully authenticated.

8. The system of claim 7, wherein the integrated control unit is further configured to:
determine distance values of a mobile device that has been successfully authenticated first and mobile devices that have been successfully authenticated later in response that there is the another mobile device that has been successfully authenticated; and
determine a difference value between the distance values and perform connection to the mobile device that has been successfully authenticated first in response that the determined difference value is greater than a predetermined threshold value.

9. The system of claim 8, wherein the integrated control unit is further configured to perform connection to a mobile device including a minimum distance value from the vehicle among all mobile devices in response that the determined difference value is equal to or lower than the predetermined threshold value.

10. The system of claim 1, wherein the authentication control unit is configured to transmit the result of performing the pre-authentication to the integrated control unit in response that a button operation is requested from the integrated control unit during a period in which the pre-authentication is successful.

11. A method of performing pre-authentication, the method comprising:
performing, by an integrated control unit including a processor, pre-authentication with a mobile device in which a digital key is provided in response that the mobile device enters a predetermined authentication area; and
performing pre-authentication with the integrated control unit in response that the pre-authentication with the mobile device is successful and storing a result of performing the pre-authentication.

12. The method of claim 11, further including:
in the performing of the pre-authentication,
checking, by the integrated control unit, whether the mobile device is approaching a vehicle in response that the mobile device enters the authentication area; and
performing, by the integrated control unit, the pre-authentication in response that the mobile device is approaching the vehicle.

13. The method of claim 12, further including: in the performing of the pre-authentication,
detecting, by the integrated control unit, a received signal strength indicator (RSSI) of a wireless signal received from the mobile device, and
checking, by the integrated control unit, whether the mobile device is approaching the vehicle based on the detected RSSI.

14. The method of claim 11, further including: in the performing of the pre-authentication,
checking, by the integrated control unit, whether a number of times the pre-authentication is performed is greater than or equal to n times in response that the performing of the pre-authentication is determined, wherein the n is a positive integer; and
performing, by the integrated control unit, the pre-authentication in response that the number of times the pre-authentication is performed does is less than the n times.

15. The method of claim 14, further including: in the performing of the pre-authentication,
checking, by the integrated control unit, whether the number of times the pre-authentication fails is greater than or equal to m times in response that the number of times the pre-authentication is performed is greater than or equal to the n times, wherein the m is a positive integer, and
performing, by the integrated control unit, the pre-authentication in response that the number of times the pre-authentication fails is less than the m times.

16. The method of claim 15, further including: in the performing of the pre-authentication,
starting, by the integrated control unit, a timer to count a time in response that the pre-authentication is successful as the result of performing the pre-authentication, and
performing, by the integrated control unit, the pre-authentication again based on the counted time.

17. The method of claim 11, further including: in the performing of the pre-authentication,
checking, by the integrated control unit, whether there is another mobile device that has been successfully authenticated in response that the performing of the pre-authentication is determined, and
performing, by the integrated control unit, the pre-authentication with a mobile device having a shortest distance from the vehicle among all mobile devices in response that there is the another mobile device that has been successfully authenticated.

18. The method of claim 17, further including: in the performing of the pre-authentication,
determining, by the integrated control unit, distance values of a mobile device that has been successfully authenticated first and mobile devices that have been successfully authenticated later in response that there is the another mobile device that has been successfully authenticated, and
determining, by the integrated control unit, a difference value between the distance values and performing connection to the mobile device that has been successfully authenticated first in response that the determined difference value is greater than a predetermined threshold value.

19. The method of claim 18, further including: in the performing of the pre-authentication,
performing, by the integrated control unit, connection to a mobile device having a minimum distance value from the vehicle among all mobile devices in response that the determined difference value is equal to or lower than the predetermined threshold value.

20. The method of claim 11, further including: in the storing of the result,
transmitting a result of performing the pre-authentication to the integrated control unit in response that a button operation is requested from the integrated control unit during a period in which the pre-authentication is successful.
